(19) United States
(12) Patent Application Publication
(10) Pub. No.: US 2015/0273396 A1
(43) Pub. Date: Oct. 1, 2015

(54) DRAW SOLUTIONS AND DRAW SOLUTE RECOVERY FOR OSMOTICALLY DRIVEN MEMBRANE PROCESSES

(71) Applicant: OASYS WATER, INC., Boston, MA (US)

(72) Inventors: Nathan T. Hancock, Boston, MA (US); Christopher Drover, Somerville, MA (US); Zachary Helm, Waltham, MA (US)

(21) Appl. No.: 14/440,244

(22) PCT Filed: Nov. 13, 2013
(86) PCT No.: PCT/US2013/069895

§ 371 Date: May 1, 2015

Related U.S. Application Data
(60) Provisional application No. 61/777,774, filed on Mar. 12, 2013.
(60) Provisional application No. 61/773,588, filed on Mar. 6, 2013.
(60) Provisional application No. 61/727,424, filed on Nov. 16, 2012.
(60) Provisional application No. 61/727,426, filed on Nov. 16, 2012.

(51) Int. Cl. B01D 61/00; C02F 1/469

(52) U.S. Cl. CPC B01D 61/005; B01D 61/002; C02F 1/4693

(57) ABSTRACT

The invention generally relates to osmotically driven membrane processes and more particularly to draw solutions and draw solute recovery techniques for osmotically driven membrane processes.

### CROSS-REFERENCE TO RELATED APPLICATIONS

This application claims priority to and the benefit of U.S. Provisional Patent Application Nos. 61/727,424, filed Nov. 16, 2012; 61/727,426, filed Nov. 16, 2012; 61/773,588, filed Mar. 6, 2013; and 61/777,774, filed Mar. 12, 2013; the entire disclosures of which are hereby incorporated by reference herein in their entireties.

### FIELD OF THE TECHNOLOGY

Generally, the invention relates to osmotically driven membrane processes and more particularly to draw solutions and draw solute recovery techniques for osmotically driven membrane processes.

### BACKGROUND

In general, osmotically driven membrane processes involve two solutions separated by a semi-permeable membrane. One solution may be, for example, seawater, while the other solution is a concentrated solution that generates a concentration gradient between the seawater and the concentrated solution. This gradient draws water from the seawater across the membrane, which selectively permits water to pass, but not salts, into the concentrated solution. Gradually, the water entering the concentrated solution dilutes the solution. The solutes then need to be removed from the dilute solution to generate potable water. Traditionally, the potable water was obtained via distillation; however, the solutes were typically not recovered and recycled.

### SUMMARY

The invention generally relates to novel draw solutions and systems and methods for recovering/recycling the draw solutes of those solutions. The draw solutions are used in various osmotically driven membrane systems and methods, for example; forward osmosis (FO), pressure retarded osmosis (PRO), osmotic dilution (OD), direct osmotic concentration (DOC), or other processes that rely on the concentration (or variability thereof) of solutes in a solution. The systems and methods for draw solute recovery may be incorporated in the osmotically driven membrane systems/processes. Examples of osmotically driven membrane processes are disclosed in U.S. Pat. Nos. 6,391,205 and 7,560,029; and U.S. Patent Publication Nos. 2011/0203994, 2012/0273417, and 2012/0267306; the disclosures of which are hereby incorporated herein by reference in their entireties. In addition, a variety of draw solute recovery systems are disclosed in U.S. Pat. No. 8,246,791 and U.S. Patent Publication No. 2012/0067819, the disclosures of which are also hereby incorporated herein by reference in their entireties.

Additionally, the various draw solution compositions disclosed herein are not necessarily suited to every osmotically driven membrane process and can be selected to suit a particular application; for example, FO or PRO and related aspects, such as the method of draw solute recovery, membrane/system compatibility, desired flux, feed solution, etc. Ideally, the selected draw solution will exhibit at least some of the following characteristics: relatively low cost, good solvent flux, reduced need for pretreatment, increased system efficiency, pH flexibility, and low reverse flux.

Generally, the draw solution is an aqueous solution, i.e., the solvent is water; however, in some embodiments the draw solution is a non-aqueous solution using, for example, an organic solvent. The draw solution is intended to contain a higher concentration of solute relative to a feed or first solution so as to generate an osmotic pressure within the osmotically driven membrane system. The osmotic pressure may be used for a variety of purposes, including desalination, water treatment, solute concentration, power generation, and other applications. In some embodiments, the draw solution may include one or more removable solutes. In at least some embodiments, thermally removable (thermolytic) solutes may be used. For example, the draw solution may comprise a thermolytic salt solution, such as that disclosed in U.S. Pat. No. 7,560,029. Other possible thermolytic salts include various ionic species, such as chloride, sulfate, bromide, silicate, iodide, phosphate, sodium, magnesium, calcium, potassium, nitrate, arsenic, lithium, boron, strontium, molybdenum, manganese, aluminum, cadmium, chromium, cobalt, copper, iron, lead, nickel, selenium, silver, and zinc.

Generally, the feed or first solution may be any solution containing solvent and one or more solutes for which separation, purification, or other treatment is desired. In some embodiments, the first solution may be non-potable water such as seawater, salt water, brackish water, gray water, and some industrial water. In other embodiments, the first solution may be a process stream containing one or more solutes, such as target species, which it is desirable to concentrate, isolate, or recover. Such streams may be from an industrial process, such as a pharmaceutical or food grade application. Target species may include pharmaceuticals, salts, enzymes, proteins, catalysts, microorganisms, organic compounds, inorganic compounds, chemical precursors, chemical products, colloids, food products, or contaminants. The first solution may be delivered to a forward osmosis membrane treatment system from an upstream unit operation such as an industrial facility, or any other source, such as the ocean.

In one aspect, the invention relates to a draw solution for an osmotically driven membrane system. The draw solution includes an aqueous solvent having a pH in the range of 2-11 and a draw solute having a cation source and an anion source. Alternatively, the solvent can have a pH range of 3-12, 6-10, or 7-12. The cation source includes at least one volatile gas-based cation (e.g., NH₃), and the anion source includes at least one volatile gas-based anion (e.g., CO₂). The anion source further comprises a viscosity modifier.

In various embodiments, the cation source includes an alkyl amine having a boiling point less than water and the viscosity modifier includes hydrogen sulfide. The cation source can be derived from a blend of cations including, for example, an alkyl amine, ammonia, sodium hydroxide, and/or other volatile/non-volatile cations. The anion source can be derived from a blend of anions including, for example, hydrogen sulfide, carbon dioxide, hydrogen chloride, sulfur dioxide, sulfur trioxide and/or other volatile/non-volatile anions. In one or more embodiments, the viscosity modifier includes at least one of ethanol, polyoxyalkylene, sodium xylene sulfonate, polyacrylics, sodium lauryl sulfonate, ethers, ether derivatives, sulfides, sulfide derivatives, and combinations thereof.

In another aspect, the invention relates to a draw solution recovery method for a draw solution including one or more thiol based draw solutes. The method includes the steps of introducing a dilute draw solution comprising a solvent and at least one thiol based draw solute to an oxidizing environment; stripping hydrogen ions from the draw solute; passing the hydrogen ions across a barrier to, for example, isolate the hydrogen ions from the remaining draw solute molecule(s); bonding the remaining solute via disulfide polymerization, thereby forming disulfide bridges between the remaining solute; directing the solvent and polymerized solutes to a filtration module; separating at least a portion of the solvent from the polymerized solute to produce a product solvent; directing the polymerized solute and any remaining solvent to a reducing environment; depolymerizing the polymerized solute to break the disulfide bridges; and reintroducing the hydrogen ions to the depolymerized draw solute to reform the at least one thiol based draw solute and create a concentrated draw solution. Generally, “solute” is used herein to denote one or more solute molecules, i.e., solutes.

In various embodiments, the polymerization and de-polymerization steps may be enhanced by the introduction of heat, light, a catalyst, and/or other energy source. The method may also include the step of directing the concentrated draw solution to an osmotically driven membrane system. In one or more embodiments, the dilute draw solution is introduced from an osmotically driven membrane system. The filtration module can include a reverse osmosis module, a microfiltration module, a nanofiltration module, an ultrafiltration module, hydrocyclone, or combination thereof to separate the product solvent from the dilute draw solution. Additionally, the oxidizing environment and the reducing environment can be part of one or more redox cells separated by one or more hydrogen permeable barriers.

In yet another aspect, the invention relates to an osmotically driven membrane system and related process. Generally, the system includes one or more forward osmosis membrane modules including one or more membranes in each, a source of feed solution in fluid communication with one side of the one or more membranes, a source of concentrated draw solution in fluid communication with an opposite side of the one or more membranes, and a draw solution recovery system in fluid communication with the forward osmosis membrane module(s). The concentrated draw solution includes an aqueous solvent having a pH in the range of 2-11 and a draw solute including a cation source having at least one volatile gas-based cation and an anion source having at least one volatile gas-based anion. The anion source can further include a viscosity modifier.

In various embodiments, the draw solution recovery system includes at least one redox cell in fluid communication with the opposite side of the one or more membranes and configured for receiving a dilute draw solution from the forward osmosis membrane module(s) and a filtration module in fluid communication with the at least one redox cell. The at least one redox cell includes an oxidizing environment and a reducing environment separated by an element specific (e.g., hydrogen) permeable barrier. The system can further include an energy source in communication with the at least one redox cell.

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention and are not intended as a definition of the limits of the invention. For purposes of clarity, not every component may be labeled in every drawing. In the following description, various embodiments of the present invention are described with reference to the following drawings, in which:

FIG. 1 is a schematic representation of an exemplary osmotically driven membrane system/process using a solute recovery system in accordance with one or more embodiments of the invention;

FIG. 2 is a reaction scheme of a draw solution that uses thermolytic covalent sequestration for recovering and recycling the draw solutes in accordance with one or more embodiments of the invention;

FIGS. 3A-3C are schematic representations of the various chemical interactions of another method of draw solute recovery in accordance with one or more embodiments of the invention.

FIG. 4 is a schematic representation of a reactive extraction method of draw solute recovery in accordance with one or more embodiments of the invention;

FIGS. 5A and 5B are pictorial representations of the recovery phase and the recycling phase of a reduction-oxidation operation for recovering/recycling draw solutes in accordance with one or more embodiments of the invention;

FIG. 6 is a pictorial representation of one embodiment of a reduction-oxidation operation in accordance with one or more embodiments of the invention;

FIGS. 7A and 7B are pictorial representations of two alternative embodiments of a reduction-oxidation operation for recovering/recycling draw solutes in accordance with one or more embodiments of the invention;

FIG. 8 is a schematic representation of a reduction-oxidation operation for a draw solute recovery system in accordance with one or more embodiments of the invention;

FIG. 9 is a schematic representation of a photo-reactive polymerization method of draw solute recovery in accordance with one or more embodiments of the invention;

FIG. 10A is a schematic representation of an alternative polymerization method of draw solute recovery in accordance with one or more embodiments of the invention;

FIG. 10B is a pictorial representation of a reduction-oxidation operation for recovering/recycling draw solutes in accordance with the embodiment of FIG. 10A;

FIG. 11 is a schematic representation of one embodiment of a draw solution recovery system in accordance with one or more embodiments of the invention; and

FIGS. 12-14 are schematic representations of alternative draw solution recovery systems in accordance with one or more embodiments of the invention.

### DETAILED DESCRIPTION

Various embodiments of the invention may be used in any osmotically driven membrane process, such as FO, PRO, OD, DOC, etc. An osmotically driven membrane process for extracting a solvent from a solution may generally involve exposing the solution to a first surface of a forward osmosis membrane. In some embodiments, the first solution (known as a process or feed solution) may be seawater, brackish water, wastewater, contaminated water, a process stream, or other aqueous solution. In at least one embodiment, the solvent is water; however, other embodiments may use non-aqueous solvents. A second solution (known as a draw solution) with an increased concentration of solute(s) relative to that of the first solution may be exposed to a second opposed surface of the forward osmosis membrane. Solvent, for example water, may then be drawn from the first solution through the forward osmosis membrane and into the second solution generating a solvent-enriched solution via forward osmosis.

Forward osmosis generally utilizes fluid transfer properties involving movement of solvent from a less concentrated solution to a more concentrated solution. Osmotic pressure generally promotes transport of the solvent across a forward osmosis membrane from the feed solution to the draw solution. The solvent-enriched solution, also referred to as a dilute draw solution, may be collected at a first outlet and undergo a further separation process. In some non-limiting embodiments, purified water may be produced as a product from the solvent-enriched solution. A second product stream, i.e., a depleted or concentrated process solution, may be collected at a second outlet for discharge or further treatment. The concentrated process solution may contain one or more target compounds that it may be desirable to concentrate or otherwise isolate for downstream use.

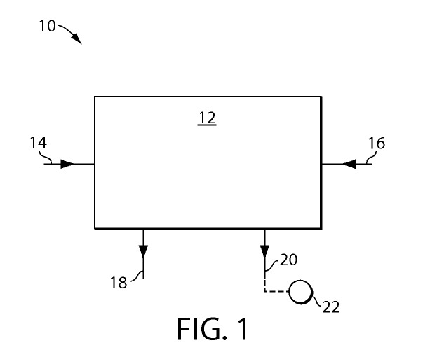

FIG. 1 depicts one exemplary osmotically driven membrane system/process 10 utilizing a draw solute recovery system 22 in accordance with one or more embodiments of the invention. As shown in FIG. 1, the system/process 10 includes a forward osmosis module 12, such as those incorporated by reference herein. The module 12 is in fluid communication with a feed solution source or stream 14 and a draw solution source or stream 16. The draw solution source 16 can include, for example, a saline stream, such as sea water, or another solution as described herein that can act as an osmotic agent to dewater the feed source 14 by osmosis through a forward osmosis membrane within the module 12. The module 12 outputs a stream of concentrated solution 18 from the feed stream 14 that can be further processed. The module 12 also outputs a dilute draw solution 20 that can be further processed via the recovery system 22, as described herein, where draw solutes and a target solvent can be recovered. In accordance with one or more embodiments of the invention, the draw solutes are recovered for reuse.

The forward osmosis membranes may generally be semi-permeable, for example, allowing the passage of a solvent such as water, but excluding dissolved solutes therein, such as those disclosed herein. Many types of semi-permeable membranes are suitable for this purpose provided that they are capable of allowing the passage of the solvent, while blocking the passage of the solutes and not reacting with the solutes in the solution. The membrane can have a variety of configurations, including thin films, hollow fiber, spiral wound, monofilaments and disk tubes. There are numerous well-known, commercially available semi-permeable membranes that are characterized by having pores small enough to allow water to pass while screening out solute molecules, such as, for example, sodium chloride and their ionic molecular species such as chloride. Such semi-permeable membranes can be made of organic or inorganic materials, as long as the material selected is compatible with the particular draw solution used. In some embodiments, membranes made of materials such as cellulose acetate, cellulose nitrate, polysulfone, polyvinylidene fluoride, polyamide and acrylonitrile co-polymers may be used. Other membranes may be mineral membranes or ceramic membranes made of materials such as Zr0₂ and Ti0₂.

Generally, the material selected for use as the semi-permeable membrane should be able to withstand various process conditions to which the membrane may be subjected. For example, it may be desirable that the membrane be able to withstand elevated temperatures, such as those associated with sterilization or other high temperature processes. In some embodiments, a forward osmosis membrane module may be operated at a temperature in the range of about 0 degrees Celsius to about 100 degrees Celsius. In some non-limiting embodiments, process temperatures may range from about 40 degrees Celsius to about 50 degrees Celsius. Likewise, it may be desirable for the membrane to be able to maintain integrity under various pH conditions. For example, one or more solutions in the membrane environment, such as the draw solution, may be more or less acidic or basic. In some non-limiting embodiments, a forward osmosis membrane module may be operated at a pH level of between about 2 and about 11. In certain non-limiting embodiments, the pH level may be about 7 to about 10. The membranes used need not be made out of one of these materials and they can be composites of various materials. In at least one embodiment, the membrane may be an asymmetric membrane, such as with an active layer on a first surface, and a supporting layer on a second surface. In some embodiments, an active layer may generally be a rejecting layer. For example, a rejecting layer may block passage of salts in some non-limiting embodiments. In some embodiments, a supporting layer, such as a backing layer, may generally be inactive.

One example of a suitable membrane is disclosed in U.S. Pat. No. 8,181,794, the disclosure of which is hereby incorporated herein by reference in its entirety. The membrane disclosed therein can be further enhanced by, for example, using polyethersulfone support structures, which may produce a different pore structure and provide improved flux/rejection properties in FO or RO applications. Additionally, the charge on one of the membrane layers, for example, the barrier layer, can be changed, which may also improve the performance of the membrane. Also, the various layers of the membrane can be modified by the incorporation of nanoparticles or anti-microbial substances. For example, layered double hydroxide (LDH) nanoparticles can be incorporated into the barrier layer to improve the flux/rejection characteristics of the membrane. These various modifications may also improve the reverse salt flux performance of the membrane. Additionally, these various improvements are also applicable to hollow fiber type membranes.

In accordance with one or more embodiments of the invention, a draw solution should generally create osmotic pressure and be removable, such as for regeneration and recycling. In some embodiments, a draw solution may be characterized by an ability to undergo a catalyzed phase change in which a draw solute is changed to a gas or solid that can be precipitated from an aqueous solution using a catalyst. In some embodiments, the mechanism may be coupled with some other means, such as heating, cooling, addition of a reactant, or introduction of an electrical or magnetic field. In other embodiments, a chemical may be introduced to react with a draw solute reversibly or irreversibly to reduce its concentration, change its rejection characteristics by the membrane, or in other ways make it easier to remove. In at least one embodiment, introduction of an electrical field may cause a change in the draw solute, such as a phase change, change in degree of ionization, or other electrically induced changes that make the solute easier to remove. In some embodiments, solute passage and/or rejection may be manipulated, such as by adjusting a pH level, adjusting the ionic nature of a solute, modifying the physical size of a solute or promoting another change that causes the draw solute to readily pass through a membrane where previously it had been rejected. For example, an ionic species may be rendered nonionic, or a large species may be made relatively smaller. In some embodiments, separation techniques not using heating, such as electrodialysis (EDI), cooling, vacuum or pressurization may be implemented. In at least one embodiment, an electrical gradient may be implemented in accordance with one or more known separation techniques. In some embodiments, certain separation techniques, such as EDI, may be used to reduce species to be separated such as to lower electrical requirements. In at least one embodiment, the solubility of organic species may be manipulated, such as by changing temperature, pressure, pH or other characteristic of the solution. In at least some embodiments, ion exchange separation may be implemented, such as sodium recharge ion exchange techniques, or acid and base recharged ion exchange to recycle draw solutes, including, for example, ammonium salts.

The various draw solutions described herein typically include draw solutes that are easily removable and recyclable via, for example, thermal recovery (e.g., use of heating and/or cooling), chemical recovery (e.g., reactive extraction), electro-chemical recovery (e.g., reduction-oxidation reaction (Redox)), photo-chemical recovery (e.g., use of ultraviolet light (UV)), filtration recovery (e.g., reverse osmosis (RO) or nanofiltration) or combinations thereof. Table 1 lists various draw solutions and their recovery methods, some of which are discussed hereinbelow.

TABLE 1

| Draw Solution | Recovery Method(s) |
|---|---|
| NH₃/CO₂ | Thermal - LGH |
| R₃—N/CO₂ | Thermal - LGH |
| R—NH₂/H₂S | Thermal - LGH |
| ZnBr₂ | Redox/battery |
| Diels-Alder/Retrograde Diels-Alder | Resin with LGH |
| Magnetic Nanoparticles | Electric Field/MF, UF, NF |
| Hydrogels | Light, heat, pH, IS, pressure |
| Ion Pairs/Seawater | RO/NF/UF/MF |
| Ion Pairs | EDI/Electrodialysis |
| Micelles at Kraft Point | Heat/crystallization |
| Dendrimers | pH/UF |
| RO Brines | RO/NF/UF/MF |
| Hydrophilic Polymers | Nanoparticles to capture, |
| | LGH to release |
| Albumin | LGH |

Generally, thermal recovery draw solutions rely on the use of thermolytic/volatile salts or thermo-organic compounds that, in at least one embodiment, allow for thermolytic covalent sequestration. The volatile salts can include various combinations of, for example, hydrogen sulfide (H₂S), carbon dioxide (CO₂), ammonia (NH₃), and various alkyl amines. One example is NH₄⁺+NH₃+CO₂, which combines to form NH₄⁺+NH₂CO₂⁻, as disclosed in U.S. Pat. No. 7,560,029. In one embodiment, low-grade heat (LGH) can be used recover the salts as follows: NH₄⁺+NH₂CO₂⁻ (+LGH)=NH₄⁺+NH₃+CO₂. U.S. Patent Publication No. 2013/0248447, the disclosure of which is hereby incorporated herein by reference in its entirety, discloses another example of a thermally recoverable draw solution. In alternative embodiments, the draw solution can incorporate trimethylamine (or other alkyl amine). One example of such a solution is as follows: NH(CH₃)₃⁺+NH₃+CO₂, which combines to form NH(CH₃)₃⁺+NH₂CO₂⁻. The salts can also be recovered with LGH as follows: NH(CH₃)₃⁺+NH₂CO₂⁻ (+LGH)=NH(CH₃)₃⁺+NH₃+CO₂. Generally, the carbon bound amines act as a counter ion to the carbamate anion. Examples of suitable amines include alkyl amines with a boiling point less than that of water, such as methylamine, dimethylamine, and propylamine. Generally, amines having a boiling point of 65° C. or less make them ideal for low heat recovery. Some advantages of draw solutions that use alkyl amines are that the larger amine groups are less likely to exhibit selective permeability across the membrane, the solubility of the carbon bound amines are on the order of 6-10 molar (M), and carbamate solubility may be higher than in ammonium. The increased solubility of the draw solutes results in higher osmotic pressures (it). Additionally, alternative gases to CO₂ and H₂S are contemplated and considered within the scope of the invention.

Generally, certain alkyl amines can create a higher viscosity draw solution than may be desirable for certain applications. In various embodiments, a viscosity modifier may be added to the solution to suit a particular application. Such a modifier may be volatile or non-volatile, and in some embodiments is selected so that its volatility is comparable to the volatility of the primary draw solutes. In one exemplary embodiment, the modifier is hydrogen sulfide added to an alkyl amine-carbon dioxide based draw solution. Other possible modifiers include ethanol, polyoxyalkylene, sodium xylene sulfonate, polyacrylics, sodium lauryl sulfate, ethers and their derivatives, and other sulfide derivatives. Other possible modifiers are contemplated and considered within the scope of the invention and will be selected to suit a particular application. For particular applications, it may be desirable to form the draw solution of a blend of the various draw solutes discussed herein, for example, the draw solution may include one or more substances as the cation portion of the draw solution and one or more substances as the anion portion of the draw solution. In one exemplary embodiment, the draw solution includes a blend of different amines for the cation portion and a blend of a carbonate and at least one viscosity modifier as the anion portion. Generally, the specific combinations and ratios of cations and anions will be selected to suit a particular application and be based, at least in part, on material compatibility, feed solution chemistry, environmental considerations, and the application for which the osmotically driven membrane system is used.

Another example of a thermal recovery draw solution is one that includes thermo-organic compounds, such as a dienophile, and relies on the Diels-Alder (DA) reaction. Diels-Alder reactions are well known chemical reactions in the field of organic chemistry. Recent attention has been paid to this chemistry in the realm of self-healing polymers in efforts to find materials that can be repaired by reforming or restructuring bonds to remove damage and abrasions. In one example, the draw solution includes a dienophile (or other soluble, organic alkene), for example in the form of maleic acid (and its derivatives), which produces the osmotic pressure that allows a solvent to pass through the membrane and into the draw solution. The maleic acid example is attractive, because maleic acid (and its derivatives) has a high solubility in water and could be paired with a monovalent cation of choice to produce high osmotic pressure, and high water flux, while also being easily sequestered from a dilute draw stream through a DA reaction. Maleic acid is utilized in human metabolic processes, so it is relatively non-toxic.

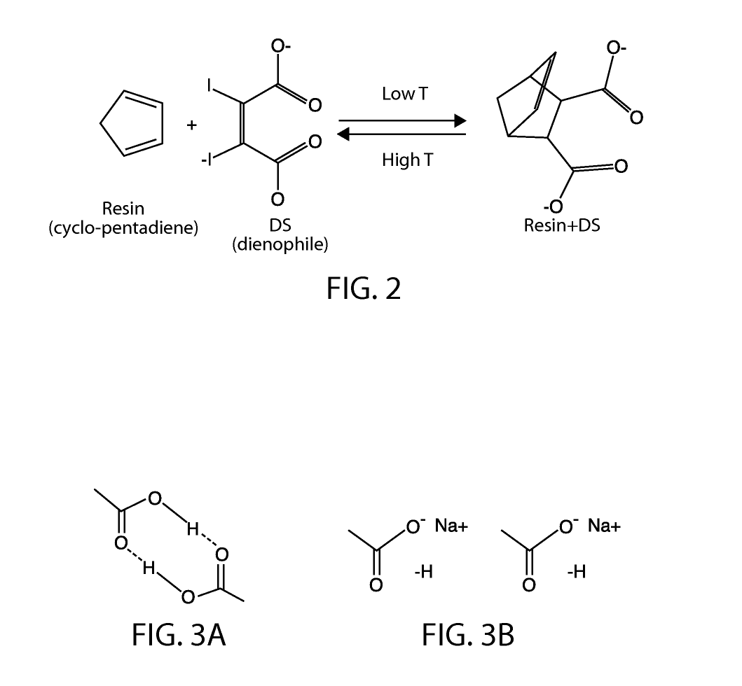

Generally, the dienophile is coupled to a resin tethered diene. The resin, for example silica, which has had a surface thereof modified to accept a diene (e.g., cyclopentadiene (C₅H₆)), is added to the now diluted draw solution. In one embodiment, the draw solution molecule (DS) is bound by the resin at ambient temperature (T) (e.g., <60° C.). At an elevated T (e.g., >60° C., but <100° C.), the reverse reaction (RDA) is favored, thus releasing the draw solute from the resin into an aqueous solution and allowing for the recovery of draw solution utilizing low grade heat. This aspect of the invention can also be coupled with a reverse osmosis process to make the entire recovery process more efficient. Generally, the heat excites the pi-orbital electrons causing the pi bonds to break, resulting in two new sigma bonds (single bonds, lower energy than pi bonds) and one new pi bond (double bond). The reaction is concerted, i.e., all the bonds break and form in a single step. The reverse reaction requires more heat, because two sigma bonds are being converted to pi bonds, but not significantly more due to ring strain exerted by the methyl bridge and the limited flexibility around the single pi bond (double bond). One example of this is shown in FIG. 2.

Once the draw solution molecule has been bound by the resin it can be removed from the solution, leaving behind a substantially pure solvent (e.g., water). The resin, which may be in slurry form, can then be exposed to the elevated temperature (or reduced temperature depending on the application) to release the draw solution molecule from the resin. The resin can then be removed by, for example, filtration, leaving behind a reconstituted draw solution. In one embodiment, the resin is contained within a slurry that can be pumped through a membrane or sent to another type of separation process. In addition, the apparatus for recovering the draw solution draw solutes can include a rapid plate settler to expedite the settling/removal of the resin. Further, an electrical signal or electro-magnetic radiation (e.g., UV light) can be used in the DA-RDA process to further expedite the process. The various means for expediting the process may eliminate the need for total DA-RDA recovery. Alternatively, the resin can be replaced by two or more monomers that react to cause the solutes to leave the aqueous phase entirely, which in some embodiments can be useful for reducing the osmotic pressure of the dilute draw solution before using, for example, an RO system to recover the product solvent from the dilute draw solution.

Other dienophiles, dienes, and resins are contemplated and considered within the scope of the invention and will be selected to suit a particular application, for example a highly soluble dienophile and the accompanying diene that produce fast, complete reactions. Additionally, depending on the nature of the dienophiles, dienes, and resins used, the forward reaction can occur at an elevated, ambient, or reduced temperature and the reverse reaction can occur at an ambient, reduced, or elevated temperature. An example of a reversible covalent attachment is disclosed in PCT Publication No. WO98/009913, the disclosure of which is hereby incorporated herein by reference in its entirety.

One of the advantages to this type of draw solution is that there are a large number of non-hazardous draw solution molecules that are available. Because different draw solution molecules can be used, essentially any counter ion can be used. Additionally, larger molecules mean less selective permeability of the molecule across the membrane, i.e., molecules with larger hydration radii are less likely to reverse flux through the membrane. Further, the volume of water that needs to be heated (or cooled) to recover the draw solute is decreased relative to recovery of the thermolytic salts, because pure water will already be recovered once the draw solute-resin compound is removed. Less heat required translates to lower recovery costs.

Chemical recovery can relate to a variety of mechanisms for isolating and recovering draw solutes. In one aspect of the invention, the chemical recovery scheme is reactive extraction to recover the draw solutes. An example of reactive extraction can be found in Application of Reactive Extraction to Recovery of Carboxylic Acids by Hong et al, Biotechnol. Bioprocess Eng. 2001, 6:386-394, the disclosure of which is hereby incorporated herein by reference in its entirety. Reactive extraction has been primarily used in removing select fatty acids and other organic chemicals from byproducts of fermentation and organic molecules of value from oils used in the power industry.

In various embodiments of the invention, the draw solute comprises an acid, for example, a carboxylic acid, such as: acetic (ethanoic), formic (methanoic), propionic (propanoic), butyric (butanoic), valeric (pentanoic), caproic (hexanoic), enanthic (heptanoic), caprylic (octanoic), pelagronic (nonanioc), capric (decanoic), tartaric, succinic, citric, lactic, and/or itaconic. Generally, the acid is combined with a counter ion (e.g., Na⁺, NH₄⁺, NH₂(CH₃)₂⁺, NH(CH₃)₃⁺, or other monovalent cations that are highly soluble in water) and a solvent (e.g., H₂O) to form the draw solution. In one example, the counter ion is ammonia (NH₃⁺) and the draw solute is an ammonium-carboxylate salt.

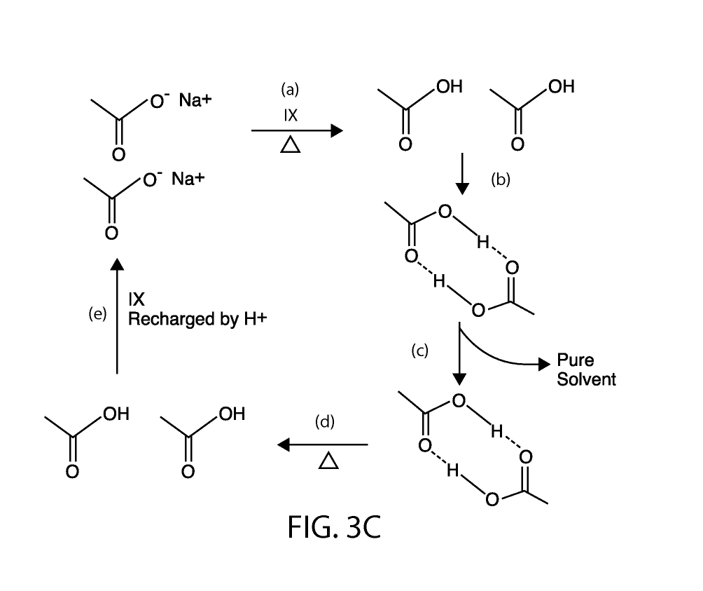

Generally, carboxylic acid monomers will form hydrogen bonds with other carboxylic acids in acidic environments leading to micelle formation and general water insolubility (FIG. 3A). In some embodiments, the use of low temperature heat will disrupt the hydrogen bonds, making the carboxylic acid draw solutes more soluble. The addition of a salt will also negate the stability of the hydrogen bonds. Alternatively or additionally, the addition of a monovalent cation (e.g., Li⁺, Na⁺, K⁺, Rb⁺, Cs⁺, Fr⁺, NH₄⁺, NH₃(CH₃)⁺, NH₂(CH₃)₂⁺, and NH(CH₃)₃⁺) countered with, for example, a hydroxide to the solution will turn the solution more basic and the draw solutes more soluble (FIG. 3B), as the ability to form hydrogen bonds is disrupted.

After the draw solution is diluted via the osmotically driven membrane process, the cation (e.g., Na⁺) can be removed from the dilute draw solution via ion exchange (IX) (e.g., WAC or SAC), allowing the carboxylic acids to polymerize, making them insoluble and removable from the product solvent. FIG. 3C depicts one exemplary embodiment of recovering the draw solutes in this manner. As shown in FIG. 3C, the dilute draw solution is exposed to the IX (while being heated (A)) (step a), exchanging the Na⁺ for the H⁺, which allows the carboxylic draw solutes to polymerize and become insoluble (step b). The now insoluble draw solutes can be removed from the solvent by any known means (e.g., precipitation and filtration) leaving behind the substantially pure solvent (step c). The recovered solvent can be used as is, sent for further processing, or otherwise disposed of depending on the nature of the solvent. The polymerized draw solutes can be disrupted by, for example, low temperature heat (or other energy source, e.g., an electrical signal, electromagnetic radiation, magnetism, ultrasound, or a chemical (A)) so that the solutes are soluble again (step d). The carboxylic draw solutes can be converted back into concentrated draw solution by, for example, recharging by IX, where the H⁺ can be exchanged with Na⁺ (step e).

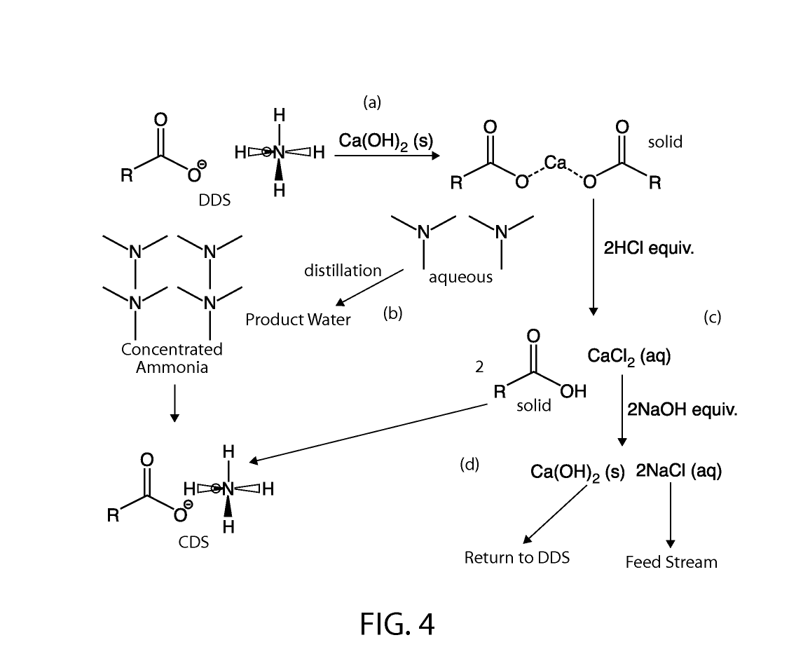

FIG. 4 depicts an alternative for recovering draw solutes that also utilizes reactive extraction. Specifically, the technique utilizes the chemical reactions to induce phase separations between a solvent (e.g., water) and draw solutions (solutes). As shown generally in FIG. 4, a dilute draw solution (DDS) is first mixed with a chemical that leads to an initial phase separation of an aqueous solution and a solid or liquid organic phase (step a). The aqueous phase contains a volatile salt that can be extracted through distillation (step b), leaving behind the product solvent (e.g., water). The solid/organic phase can then be treated with acid-base chemistry to separate the remaining draw solutes from the phase transition inducing chemical (in this case Ca(OH)₂) (step c). The volatile salt and the draw solute can be remixed to provide concentrated draw solution (CDS) and the phase transition chemical can be reused in treating the next batch of DDS (step d). Alternatively, it is possible to add a volatile compound that will trigger the separation of the draw solution from water, and upon removal of the volatile compound, the draw solutes will again become water soluble. In some embodiments, the chemical demand of these processes may be high, but it is likely possible that this reaction scheme can be made entirely sustainable without additional chemical input (e.g., utilizing EDI, augmented fuel cells, or volatile acid/base pairs). The salt pairs chosen have a relatively wide range of characteristics so selecting a draw solution to suit a particular application that has minimal selective permeability through the membrane and exhibits high water flux is reasonably easy (e.g., monovalent cations, particularly alkyl amines, ammonia, and group I cations).

In some embodiments, recovery of the draw solutes is accomplished by sparging (or otherwise introducing) an amine (e.g., a tertiary amine, such as triethylamine or trimethylamine or other long chain aliphatic alkyl amines) into the dilute draw solution, which causes the phase separation of the draw solutes. Generally, an amine that is marginally soluble in water, will preferentially diffuse into an organic solvent, and is readily removable (e.g., via distillation, membranes, etc.) is desirable. The carboxylic acid combines with the amine to form an ammonium salt that is insoluble in water. However, the amine salt maybe miscible with the draw solution solvent and, therefore, not completely removable by precipitation and/or filtration. The specific mechanism for removing the solutes will be selected based on the characteristics of the salt and the application of the system. In one embodiment, an organic solvent (e.g., propanol or hexane) is added to the dilute draw solution, which the salt partitions into (i.e., dissolves into the similar environment). The counter ion and aqueous solvent are immiscible with the organic solvent and salt, resulting in a phase separation therebetween and thereby allowing the aqueous and non-aqueous solutions to be separated. For example, because the organic solution is typically lighter than the aqueous solution, the aqueous solution can be siphoned or drained from the bottom of a vessel holding the two solutions leaving the organic solution behind.

The aqueous solution can be sent for further processing to remove the counter ion, for example, reverse osmosis, IX, or a thermal operation. The recovered solvent (e.g., water) can be returned to the feed side of the osmotically driven membrane process, sent for further processing, used as is, or otherwise discarded. In one embodiment, the non-aqueous solution is sent to a thermal operation, where the carboxylic acid can be decomposed into its constituent gas that can be recycled back (typically after being condensed) to the osmotically driven membrane process to form the basis of new concentrated draw solution. The remaining non-aqueous solution containing the organic solvent and the amine can be returned to the osmotically driven membrane process where it is added to the DDS again, thereby providing for the closed recovery of the amines.

In yet other embodiments, the carboxylic draw solutes can be recovered by the use of a copolymer. In one embodiment, the carboxylic acid based draw solutes are formed by reacting polyacrylic acid (PAA) (a carboxylic acid chain), which is readily available and relatively inexpensive in bulk, with, for example, polystyrene (PST) (or other copolymer), where the styrene replaces some of the carboxylic acid forming a chain that is no longer purely carboxylic acids, but rather carboxylic acids and styrene (PAA-ST). To recover the draw solutes from a dilute draw solution, silica or a similar insoluble substance is added to the DDS, where it binds with the PAA-ST, causing the PAA-ST to precipitate out of the DDS. The remaining solvent can be removed as previously discussed. The silica and PAA-ST can be separated via thermal processes, changes in ionic strength, pH changes, etc. The remaining PAA-ST can be used to reform the CDS. For an alternative draw solution, ammonium is reacted with the PAA, which ends up forming a zwitter ion.

Generally, the use of a carboxylic acid based draw solution is less energy intensive, because the draw solutes can be recovered via reactive extraction and no (or limited) heat is required to separate the aqueous solvent (e.g., water) and the concentrated draw solution. In addition, these draw solutes are less likely to scale, which may mean less pretreatment required, and are less likely to reverse salt flux. The use of carboxylic acid based draw solutions substitute chemical consumables for draw solute recovery as opposed to energy consumption (e.g., thermal energy). In some embodiments, it may be possible to recover some or all of the various chemicals used in the process (e.g., because of the use of both acidic and basic chemicals) by a variety of methods. For example, the system could use the afore-mentioned EDI and/or an IX column. In some cases, the solution may be too concentrated for EDI, however, use of the IX column may benefit the process. The specific acid and counter ion selected will depend on the application, compatibility with various system components (e.g., the membrane), miscibility, expected pH levels, etc.

While the specific solutes used will be selected to suit a particular application and carboxylic acids have been primarily discussed, essentially any ionomers will work for a particular application, various examples of which are discussed throughout. In one embodiment, the draw solute may include citric acid, which could be beneficial because it does not necessarily require the use of a counter ion; however, the addition of the counter ion may be desirable to generate greater flux across the membrane. In one embodiment, the draw solutes include ammonium acetate, which is very soluble and, therefore, a preferred draw solute for certain applications. In yet another embodiment, the draw solutes include propanoic acid, which may be precipitated by the addition of a salt. For example, bubbling NH₃ (or other amine) through the dilute draw solution could cause the draw solutes to crystallize and heating (e.g., with low grade heat) could decompose the salt back to the acid and NH₃ gas.

Electro-chemical recovery is generally directed to redox chemistry and can include anode/cathode reactions, capillary electrophoresis, electrodeionization, and electrodialysis. In one embodiment, the system uses a ZnBr₂ draw solution using a battery-like scheme modified to promote draw solution recovery instead of power generation. U.S. Pat. Nos. 3,625,764 and 4,482,614, the disclosures of which are hereby incorporated by reference herein in their entireties, disclose examples of basic battery technology. The whole system requires little power and could easily be run on low grade energy sources, such as solar power. The salt pairs chosen for such a scheme have extremely high solubility, for example, ZnBr₂ is soluble up to 19 M, leading to potentially very high water flux.

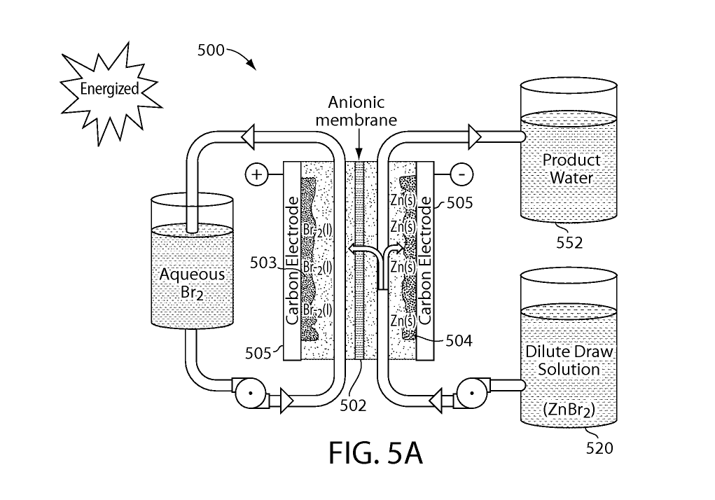

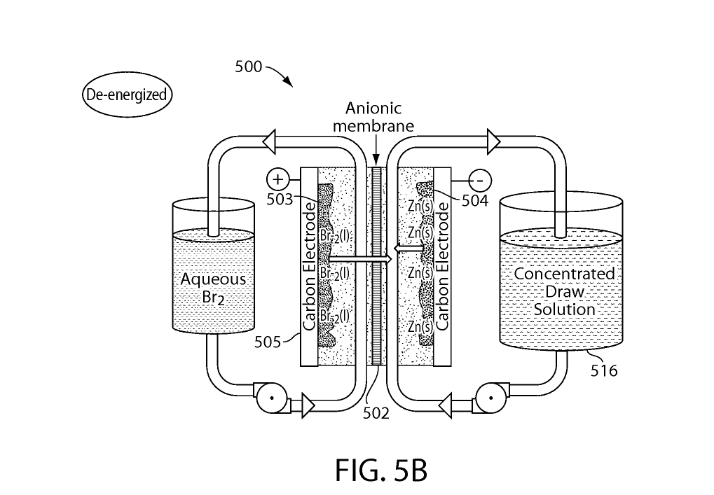

FIGS. 5A and 5B depict the stages of a basic recovery/recycling operation where the draw solutes include metal salts. Generally, any metal can be used, for example, zinc, copper, iron, manganese, tin, vanadium, lithium, etc. and any halogen or sulfate. Other possible anions include F, Cl⁻, SO₄⁻², SO₃⁻², NO₃⁻, PO₄⁻³, CO₃⁻², HCO₃⁻, CN⁻, CNO⁻, SCN⁻, and SeO₃⁻². In the figures, the draw solution is depicted as zinc bromide (ZnBr₂); however, other salts are contemplated and considered within the scope of the invention. Redox reactions are used to plate out a cation onto an anode and separate an anion to a water immiscible compound in either liquid or gas form. Upon exposure of the cation to the anion, the solution solubilizes, thus recovering the draw solution. One advantage to this system is that the various salt pairs can have extreme solubility. Additionally, non-hazardous salt pairs can be selected to maximize flux and mitigate reverse salt flux.

FIGS. 5A and 5B depict a system 500 that utilizes solar energy for recovery of the draw solutes. In one embodiment, the system 500 uses DC power from a photo-voltaic cell; however, other sources of power are also contemplated and considered within the scope of the invention. As shown in FIG. 5A, a dilute draw solution 520 containing the metal salts is introduced to the cell 502, which is energized, thereby splitting the draw solutes into half reactions. The cations 503 and anions 504 are recovered onto the separate interfaces 505 and at least a portion of the product solvent (e.g., water) 552 is removed from the cell. In the embodiment shown, the interfaces 505 are carbon electrodes.

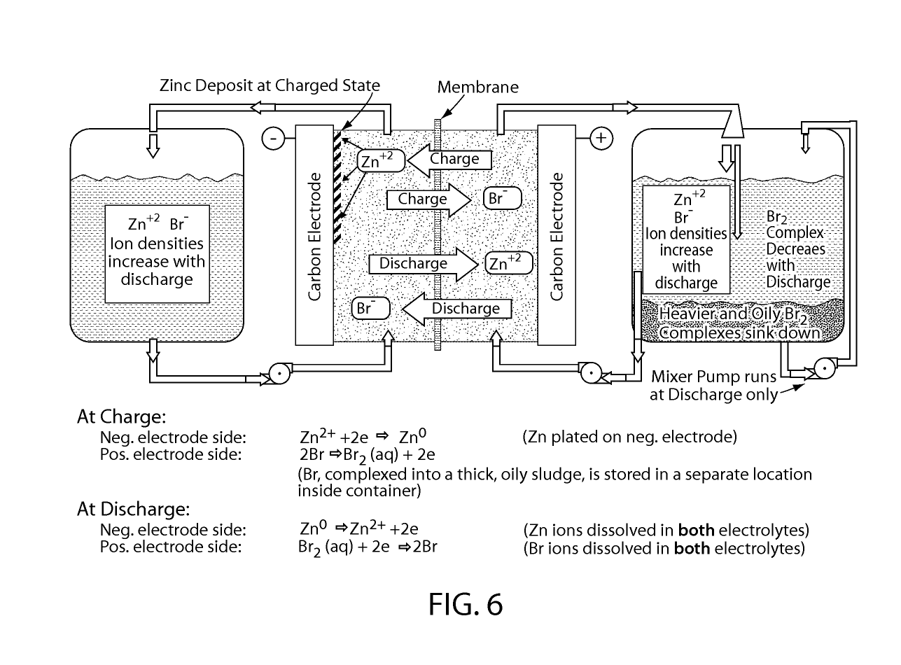

Once the product solvent 552 is removed, the system 500 can be de-energized or the charge reversed to reconstitute the draw solution, as shown in FIG. 5B. The cations 503 and anions 504 are released from the separate interfaces 505 and recombine into a remaining portion of the product solvent still in the cell to reform the concentrated draw solution 516. The reaction is substantially instantaneous and the dissolving zinc (or other metal) generates electricity as the reaction occurs. This electricity can be recaptured and used within the system. For example, two parallel cells could be used where the cells operate 180° out of phase, such that while one cell is (re)concentrating the draw solution, the electricity produced by the dissolving metal can be used to power the separation of the draw solutes in the other cell. FIG. 6 is another detailed pictorial representation of the basic system using zinc bromide as the draw solute.

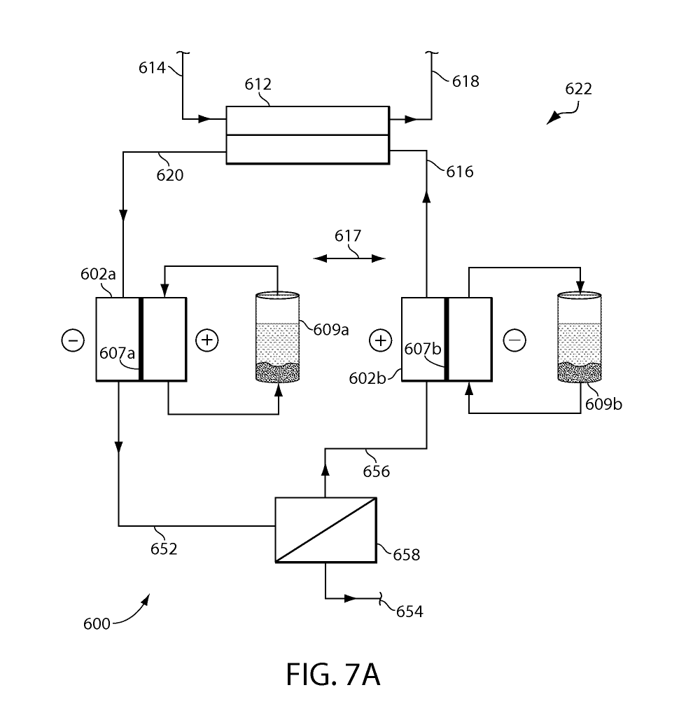

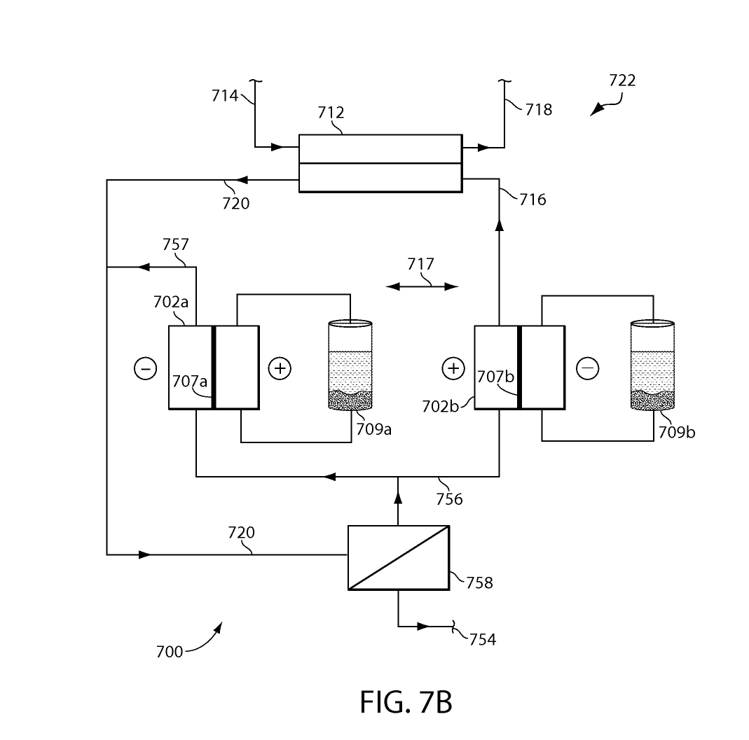

FIGS. 7A and 7B depict alternative embodiments of a system 600, 700 with a draw solution recovery mechanism that operates similarly to those described with respect to FIGS. 5A, 5B, and 6. Generally, the redox recovery method removes and stores the draw solutes from a dilute draw solution in one phase and then recycles the draw solutes back into a concentrated draw solution in the other phase.

As shown in FIG. 7A, the system 600 includes a forward osmosis module 612, similar to those described above and including a membrane; two redox cells 602a, 602b (although in some embodiments a single cell is cycled to both remove and recycle the draw solutes); and a filtration unit 658, which is a reverse osmosis module in the embodiment shown, but may also include a microfiltration module, a nanofiltration module, or an ultrafiltration module depending on the nature of the solvent and draw solutes. In operation, a feed stream 614 is introduced to the FO module 612 on one side of the membrane and a concentrated draw solution 616 is introduced to the other side of the membrane. As previously discussed, a solvent fluxes across the membrane creating a dilute draw solution 620 and a concentrated feed stream 618. The concentrated feed stream 618 can be discarded, used as is, or sent for further processing depending on the nature of the feed. The diluted draw solution 620 is directed to the draw solute recovery portion 622 of the overall system 600.

The dilute draw solution 620 is introduced to the first or recovery cell 602a. In one or more embodiments, the draw solution includes ZnBr₂ draw solutes; however, other draw solutes as disclosed above are also contemplated and considered within the scope of the invention. Within the energized cell 602a, the bromide anion (Br⁻) (in the exemplary draw solute of ZnBr₂) crosses the anionic selective membrane 607a to reach the cathode, where it is oxidized to the uncharged state Br₂ and stored as a liquid bromine phase under water 609a. The draw solute cation will be drawn to the anode (e.g., a carbon electrode) and be reduced to the uncharged state Zn, coating the electrode with a metallic layer. The remaining solution 652 with at least a portion of the draw solutes removed is directed to the reverse osmosis module 658, the operation of which produces product solvent (e.g., water) 654 that can be used as is or sent for further processing and an RO reject stream 656.

The RO reject stream 656 is then directed to the second or recycling cell 602b, where the charge is reversed from the first cell 602a. Liquid bromine from 609b is reduced at the electrode to the anion Br⁻ and travels across the anion selective membrane 607b. Zinc in the metallic layer is oxidized to the cation Zn⁺², joining the Br⁻ anion and forming concentrated draw solution 616. The concentrated draw solution 616 is directed to the FO module 612 and the process continues uninterrupted. Generally, the removal of at least a portion of the draw solutes in the first cell 602a produces a solution 652 having a lower osmotic potential, which can make the reverse osmosis process more efficient and allow for greater solvent recovery. Additionally, the release of additional draw solutes into the draw solution 616 allows for the formation of a solution with a higher osmotic pressure than can be achieved by using the reverse osmosis module 658 alone. In one illustrative example, the dilute draw solution 620 exits the FO module 612 at a first concentration (e.g., 1 molar) and then exits the recovery cell 602a at a second, lower concentration (e.g., 0.1 molar). This lower concentration solution 652 is directed to the RO module 658 and exits as a RO reject stream 656 having a third, slightly higher concentration (e.g., 0.5 molar), which is then directed to the recycling cell 602b. The solution exiting the recycling cell 602b forms the concentrated draw solution 620 having a fourth, higher concentration (e.g., 4 molar). The operation of the cells 602a, 602b can be alternated (arrow 617) or a single cell could be cycled (energized—de-energized as shown in FIGS. 5A and 5B) using tanks to operate the cell in a batch process.

FIG. 7B depicts a system 700 similar to that described with respect to FIG. 7A; however, the embodiment shown in FIG. 7B may be preferred in an application where the dilute draw solution 720 has such a low concentration of solutes that operation of the redox cell 702a would be inefficient. Although, because the concentration may be particularly low, an RO process would be fairly efficient with this dilute draw solution. As shown in FIG. 7B, the system 700 includes a FO module 712, two redox cells 702a, 702b, and a filtration module 758, all in fluid communication.

As shown in FIG. 7B, the dilute draw solution 720 is first directed to the filtration module 758, in this embodiment a RO module, where a product solvent 754 is recovered and the dilute draw solution is concentrated as an RO reject stream 756. The RO reject stream 756 can be directed to one or both of the redox cells 702a, 702b for removal/recovery of draw solutes as described above with respect to FIG. 7A. In an embodiment where the reject stream 756 is divided between the two cells 702a, 702b, the stream does not need to be divided evenly between the cells. Generally, the portion of reject stream directed to cell 702a has the draw solutes removed with the anions crossing the membrane 707a and being stored in an aqueous solution 709a while the cations are stored as a solid mass at the electrode, and the portion of the reject stream directed to the second cell 702b has the ions re-introduced into the solution to create the concentrated draw solution 716. The (re)concentrated draw solution 716 is then directed to the FO module 712 for continuous operation of the system 700. In one or more embodiments of the recovery system 722, the solution 757 exiting the first cell 702a, is directed back to the filtration module to recover additional product solvent. Generally, the removal of the additional draw solutes/anions from the RO reject stream 756 and recycling that solution back into the dilute draw solution results in additional water recovery from the filtration module 758. Additionally or alternatively, a filtration module could be added to the outtake (solution 757) of the first cell 702a for obtaining product solvent and a reject stream. The recovered product solvent can be combined with any other product solvent that has been recovered, for example, being combined with the product solvent from the first filtration module 758. The reject stream can be discarded or recycled back to the first cell 702a for continued solute and/or solvent recovery. The first or another filtration module can also be disposed in the outtake of the second cell 702b to further concentrate the draw solution being directed to the FO module 712. The recovered solvent can be directed back to any other filtration module and/or cell within the system. Generally, one or more filtration modules in combination with one or more redox cells can be fluidly coupled to recover product solvent and draw solutes to suit a particular application.

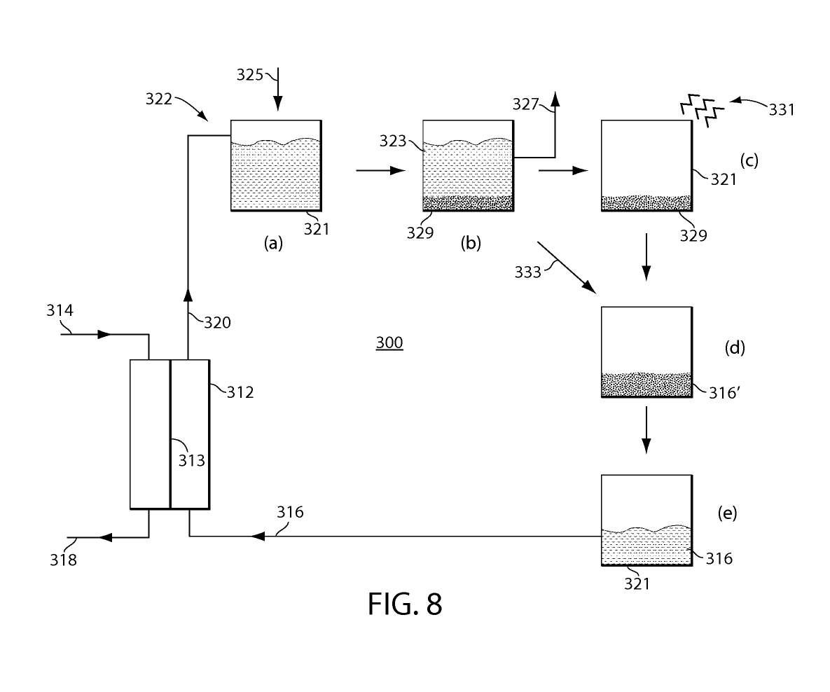

FIG. 8 depicts yet another system/method 300 for recovering draw solutes that relies on redox chemistry to recover the organic draw solutes. Generally, the system/method utilizes the addition of a substance, such as a transitional metal (e.g., iron (Fe), cobalt (Co), tungsten (W), or silver (Ag), etc.), to the DDS to bind to the solutes, thereby making them more easily removable from the DDS. FIG. 8 is described with respect to the use of Fe(III) (i.e., Fe₂O₃) and Fe(II) (i.e., Fe(II), where the system/method 300 uses Fe as the redox center, with exposure to UV light exchanging Fe(II) (reduced form of Fe) and Fe(III) (oxidized form of Fe) during the reactions. However, the use of other cations are contemplated and considered within the scope of the invention.

Typically, the reducing/oxidizing agent is an energy source, for example, an electrical signal, electro-magnetic radiation, or a chemical (e.g., the addition or subtraction of an ion) chosen to suit a particular application and whose addition or subtraction causes the desired reaction. As shown in FIG. 8, UV light is used as an oxidizing agent; however, other oxidizing and/or reducing agents are contemplated and considered within the scope of the invention. In FIG. 8, the system/method 300 is shown with an osmotically driven membrane system 312 that incorporates a forward osmosis membrane 313 and includes a feed source 314 that enters the module on one side of the membrane 313 and exits as a concentrated feed 318. A concentrated draw solution 316 is introduced on the other side of the membrane 313, where it creates an osmotic pressure difference with the feed solution causing solvent to flux across the membrane 313 and dilute the draw solution. The draw solution 316 includes an inorganic or organic draw solute (e.g., the aforementioned carboxylic acids or ZnBr₂) that can be recovered via the redox operation and is preferably highly soluble. The dilute draw solution 320 exits the module 312 and is directed to a recovery module 322. The recovery module 322 will be configured to suit a particular application, and in general will include a vessel 321 for receiving the dilute draw solution 320 and various ports and other means for introducing and removing different substances from the vessel generally or the dilute draw solution specifically. In one or more embodiments, the module 322 may include means for exchanging heat with the vessel and/or filtration means.

As shown at step (a), a substance 325, for example Fe(III) (or other relatively insoluble substance if the draw solution is aqueous), is introduced to the dilute draw solution. The means for introducing the substance 325 can include direct introduction via a port in the vessel 321 or from a hopper disposed adjacent the vessel for providing, with or without metering, the substance 325 to the vessel 321, or a separate system including, for example, a reservoir for holding the substance 325 (as either dry crystals or in a slurry) and the necessary pump (or other prime mover), plumbing, and valves for delivering the substance from the reservoir to the vessel. The means and/or the vessel 321 can also include an air source, a mixer, and/or baffles to assist in the introduction and dispersal of the substance within the dilute draw solution 320.

The draw solutes will tend to “clump” or otherwise bond with the insoluble substance 325 (e.g., via chelation, non-specific hydrophobic interactions, ionic interactions, etc.) and precipitate out of the solution (e.g., as a salt, slurry, organic mass, etc.), leaving product solvent 323 and a conglomeration of the substance and draw solutes 329, as shown in step (b). The product solvent 323 (e.g., water) can be removed from the vessel via a port or other means 327 and sent for further processing, disposed of, or used as is. In one embodiment, the means for removing the product water can include a pump and filtration module, along with any necessary plumbing, valves, and controls. Optionally, the product solvent 323 can be pumped back to the osmotically driven membrane process feed 314.

As shown at step (c), the remaining conglomeration 329 and any remaining solvent are exposed to an energy source 331. In one or more embodiments, the energy source 331 is an electro-magnetic signal, such as UV radiation; however, other energy sources such as an electrical signal, magnetism, ultrasound, a force gradient, or chemical addition/subtraction are contemplated and considered within the scope of the invention. The conglomeration 329 may be exposed to the energy source 331 while in the vessel 321 or may be transferred to a more suitable environment depending on the nature of the substance 325, the draw solutes, and/or the energy source 331. In the case of Fe(III), exposure to the UV energy source 331 will convert the Fe(III) to Fe(II), which is soluble and releases the organic draw solutes back into the remaining solvent, thereby reconstituting the concentrated draw solution 316′, although with the Fe(II) (or other substance) remaining therein.

The remaining substance can be removed via various mechanisms. In one embodiment, as shown at step (d), a resin 333 can be added to the solution 316′. The resin 333 preferentially binds with the substance 325 causing the substance and resin to precipitate out of the solution 316′, where it can be filtered out of the solution 316′, or removed by other known mechanisms, leaving behind the concentrated draw solution, as shown at step (e). In some embodiments, the resin and substance can be separated and recycled by, for example, exposure to an energy source (e.g., thermal, electrical, electro-magnetic, chemical, magnetic, etc.). In alternative embodiments, the system/process 300 can utilize reactive extraction to recover the substance. For example, a sulfide can be introduced to the solution 316′ at step (d) instead of the resin. The sulfide will bind with the Fe(II), forming iron sulfide, which precipitates out of the solution 316′. In some embodiments, pretreatment of the solution/substance 225 to be added to the dilute draw solution may be required. For example, where Fe is used for the redox operation, it may be desirable to treat the Fe solution to remove excess Fe counter ions, leaving only OH— to act as the counter ion for the Fe.

Additionally or alternatively, the foregoing embodiments of the invention can be used to lower the osmotic pressure of the draw solution, which can improve the efficiency of an auxiliary process, such as reverse osmosis. For example, the insoluble substance (e.g., Fe(III)) will bind to the draw solutes causing them to fall out of solution, thereby further lowering the osmotic pressure of the DDS, which enhances the solvent recovery of the reverse osmosis process. Examples of these auxiliary processes are described in U.S. Provisional Patent Application Ser. No. 61/762,385, filed Feb. 8, 2013, the disclosure of which is hereby incorporated herein by reference in its entirety.

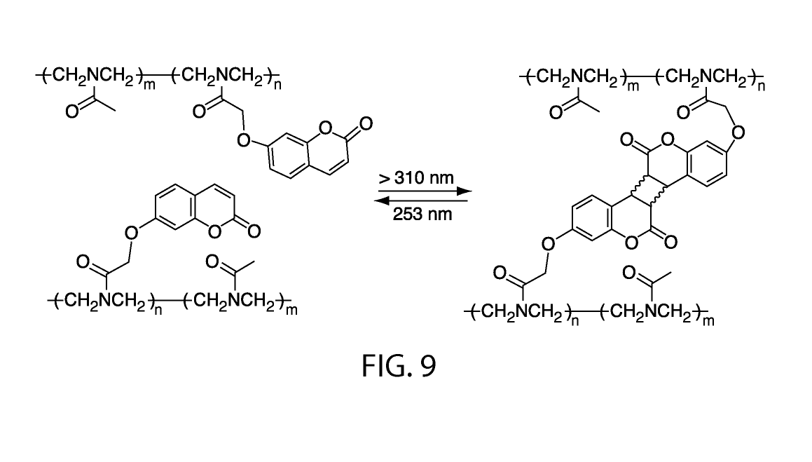

Additional draw solutions include the use of various polymer based draw solutes. For example, the draw solute could include an amphiphilic copolymer that could be recovered via a non-specific hydrophobic Van der Waals interaction. In another embodiment, the polymer based draw solutes are cross-linked by exposure to UV light to extract them from the solvent, which can then be removed from the system. The solutes can be broken back up under LGH conditions. Additionally, various polymer based draw solutions can be recovered/recycled by exposure to different wavelengths of light, an example of which is described with respect to FIG. 9. Additional draw solutions can include polar solvents that are recoverable via phase separation.

FIG. 9 depicts one example of a photo-induced polymer cross linking method (can also be classified as photo-reactive polymerization or reversible UV polymerization methods) to recover draw solutes. For example, λ₁ promotes polymerization to an insoluble species, while λ₂ promotes breakdown to soluble monomers. Essentially, at a given wavelength (in one example, >310 nm), two monomers with electrons in photoreactive pi-orbitals can be linked by exposing them to light at the given wavelength. The bonds between the monomers that form can be disrupted by exposing them to a different wavelength (in one example, 253 nm) of light, thus restoring the polymer to the original monomer sub-units. Again, this technique utilizes a low grade energy source that can be provided by, for example, solar power. Generally, the draw solutes will be selected to suit a particular application and to provide sufficient solubility to produce the required osmotic pressures to drive water flux. Typically, the pi orbital electrons are excited, leading to sigma bond formation. The reverse reaction usually requires a shorter wavelength of light, as sigma bonds are often more susceptible to UV light than visible light. In one example, a methyl methacrylate may be polymerized at 365 nm in the presence of ZnO₂ or other radical oxygen source (e.g., hydrogen peroxide).

Generally, these polymerization methods of recovering draw solutes can be used alone or in conjunction with any of the other draw solute recovery schemes described herein. For example, in one embodiment, the polymerization process can be used as a pretreatment to the DA process. By removing some of the draw solution solutes prior to exposure to the DA resin, the mass of resin required will be reduced. Also, using the polymerization process to reduce the amount of solutes in the draw solution will lower the osmotic pressure of the DDS, so that it may be more useful for an auxiliary process, as previously described.

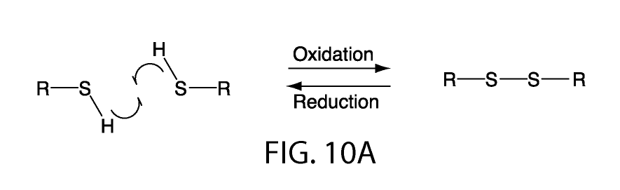

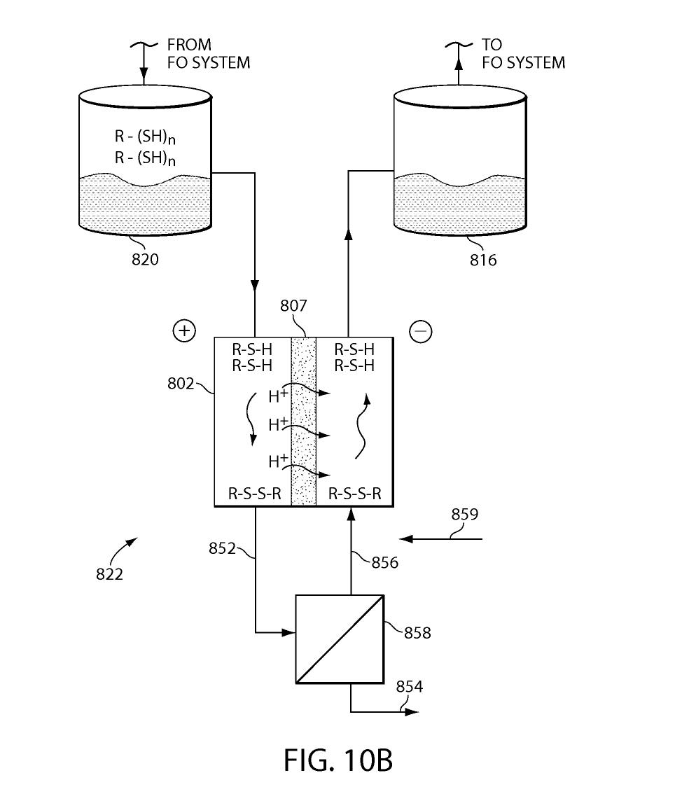

Yet another self-polymerization method of recovering draw solutes utilizes disulfide sequestration or the formation of disulfide bridges (i.e., S—S) using redox chemistry. This method can also be used to lower the osmotic pressure of the draw solution to enhance the operation of an auxiliary recovery process as previously discussed. Disulfide bridges can be formed in a number of ways. The primary mechanism is to expose sulfide containing monomers to an oxidative environment that leads to disulfide bond formation. Upon exposure of the sulfide polymer to a reducing environment, the disulfide bridge breaks providing the original monomers. See, for example, FIG. 10A. Generally, once bound, the sulfide-based polymer becomes insoluble and precipitates out of the DDS, where it can be separated from the solvent. Because the draw solutes are now precipitated out of the solution, the osmotic pressure of the DDS is lowered. However, in some embodiments, the sulfide-based polymers are not insoluble, but their formation still causes a lowering of the osmotic pressure of the DDS for use in an auxiliary process, such as RO. As shown in FIG. 10A, S=the sulfide, R=any organic unit that is integrated into the structure that includes the sulfide, and H=hydrogen; however, the hydrogen could be replaced by essentially any monovalent cation, such as Li⁺, Na⁺, K⁺, Rb⁺, Cs⁺, or Fr⁺.

Generally, in the oxidizing environment (typically high pH), the protons on the sulfides can be supported in solution more readily. The free electrons associated with the sulfide are in the higher orbitals (d-orbitals) so they will easily be shared with other electronegative species, i.e., the other sulfides. Because the sulfides have access to higher orbitals, they can support more electrons, and minimal energy is required to transfer these high orbital electrons. The reverse reaction proceeds in a reducing environment (typically low pH), where there is a higher proton concentration, such that the free electrons of the sulfide are shared with the protons and the sulfide bridge bonds are broken.

The formation and breakdown of the sulfide bridges can be accomplished in several manners. In one embodiment, the reactions can be accomplished utilizing a modified EDI or fuel cell system that exposes the sulfide molecules to high pH and low pH environments. Additionally or alternatively, the breakdown of the disulfide bond can be expedited by heating the polymer. In another embodiment, the formation and/or breakdown of the sulfide bridges can be accomplished by exposing the solutes to electromagnetic radiation, for example exposing the polymer to UV-light, where a first wavelength causes the formation of the bonds and a second wavelength causes the breakdown of the bonds. In one embodiment, the sulfide bridge is formed via an alkene that has been attached by, for example, exposure to UV light. In yet other embodiments, the oxidizing/reducing agent can be a catalyst added to the DDS. In another embodiment, a resin (e.g., silica) with a thiol group attached thereto can be added to the DDS to form the disulfide bridge. Typically, the catalyst/resin will bind with the draw solutes making them insoluble and allowing for their separation from the pure solvent. The draw solutes can then be recovered via any of the means previously discussed.

The use of sulfide draw solutes allows for more flexible draw solution chemistries, with many possible draw solution candidates. For example, thioacetate may be an ideal candidate in certain applications, because it forms extremely soluble salts and very high water flux is probable with minimal draw solution selective permeability to the membrane. Cysteine or an analogous monomer (e.g., other organic sulfides) may also be suitable for specific applications. In yet other embodiments, thiols may be desirable for their high solubility and their volatility may make them ideal for use in multi-stage draw solute recovery schemes.

FIG. 10B is a detailed pictorial representation of the recovery method disclosed with respect to FIG. 10A. Generally, this recovery method allows for the recovery and recycling of draw solutes without the need for any additional chemicals. The recovery system 822 includes a redox type cell 802 (similar to those described above) in fluid communication with a source of dilute draw solution 820, a source of concentrated draw solution 816, and a filtration module 858. In various embodiments, the draw solution contains thiol based draw solutes; R—(S—H)ₙ, where n represents any number/combination of S—H functional groups. As shown in FIG. 10B, the dilute draw solution 820 is directed to one side of the cell 802 (the oxidizing environment) where the disulfide bridges are formed (e.g., polymer R—S—S—R) and the hydrogen ions (H+) are passed through the membrane or other proton exchange media 807. Generally, the membrane 807 can be a cation exchange membrane, a gel, or other type of proton exchange membrane for introducing the hydrogen ions to the reducing environment of the cell 802.

As discussed above, the disulfide polymer may become insoluble or otherwise lower the osmotic potential of the polymerized solution 852. The solution 852 is directed to the filtration module 858 for product solvent recovery and subsequent (re)concentration of the draw solution. In one embodiment, the module 858 is a RO module; however, microfiltration, nanofiltration, and ultrafiltration are also possible depending on the nature of the draw solution. For example, where the sulfide-based polymer becomes insoluble and precipitates out or even clumps together, it may be removed via microfiltration or even by a hydrocyclone, alone or in combination with another filtration module. A product solvent 854 can be removed from the filtration module 858 for use as is or further processing. A reject stream 856 is removed from the module 858 and directed to the other side of the cell 802, where the disulfide bridges are broken and the draw solutes reformed, thereby (re)creating the concentrated draw solution 816. In one or more embodiments, heat 859 may be added to the reject stream 856 either directly or via the cell 802 to assist in the reformation of the draw solutes. The introduction of heat 859 (or other energy source/catalyst) may result in less energy being required to break the disulfide bridges. The concentrated raw solution 816 is directed to the FO module for continuous operation.

In other embodiments, hydrogels can also be used as a draw solution or for recovery of product solvent. As a draw solution, once the hydrogels become saturated (i.e., the draw solution diluted), the dilute draw solution can be exposed to UV or other specific wavelength of light as selected for the specific hydrogel. Exposure to UV causes the hydrogel to force the solvent (e.g., water) out of the dilute draw solution, thereby producing the pure solvent and a concentrated draw solution. Alternatively, the hydrogel can be used to concentrate the draw solution. In one embodiment, a draw solution that has been diluted by the influx of, for example, water can be exposed to a bed of hydrogel. The hydrogel absorbs the water and rejects the draw solutes. The rejected solutes can be recycled into a source of concentrated draw solution. The hydrogels are then exposed to the proper wavelength of light to release the water.

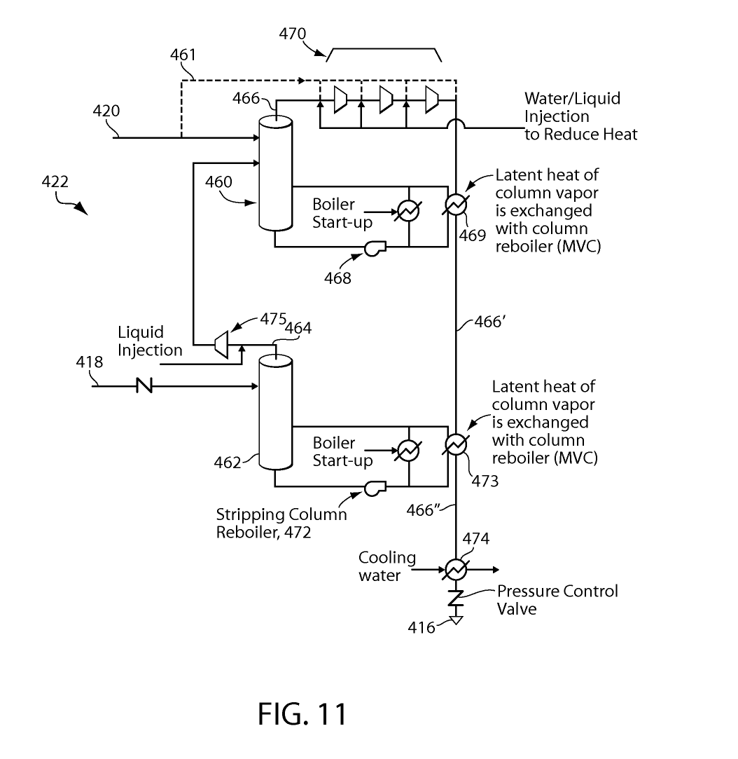

Generally, the various draw solutions disclosed can be regenerated by recovering the draw solutes and recycling same as described above with respect to particular types of draw solutions. Additional systems and methods include the use of various combinations of distillation columns, condensers, compressors, and related components, as shown in FIGS. 11-14.

FIG. 11 depicts one embodiment of a draw solute recovery system 422 as can be part of, for example, a membrane brine concentrator. As shown, the system 422 incorporates two stripping columns; the dilute draw solution (DDS) stripping column 460 and the concentrate stripping column 462. The DDS column feed includes the dilute draw solution 420 and the recovered water from an osmotically driven membrane system. The DDS column 460 eventually outputs the product solvent. The concentrate column feed includes at least the concentrated brine 418 from the membrane system. These columns are in fluid communication with one or more compressors. Mechanical vapor compression is incorporated with the distillation columns to recover and re-use heat. Membrane distillation devices are also contemplated and considered within the scope of the invention.

The vapor 464 exiting the top of the concentrate column is compressed (via compressor 475) to the pressure of the DDS column 460 and fed to the DDS column in order to reduce the steam requirements of the DDS column 460. In some embodiments, this vapor 464 includes addition draw solutes that may have reverse fluxed through the membrane of the osmotically driven membrane system and additional product solvent that did not pass through the membrane. The vapor 466 exiting the top of the DDS column 460 is compressed and exchanged with the DDS column reboiler 468. By compressing the DDS column vapor 466, the vapor condensing temperature is raised to a temperature that is higher than the DDS column reboiler 468 and, therefore, the latent heat of the vapor can be utilized as the supply heat to the column reboiler 468. Typically this vapor 466 will include the draw solutes in gaseous form. The pressure of the DDS column vapor 466 is controlled by a pressure control valve and compressed to the appropriate pressure using a 3 stage rotary lobe blower system or a screw compressor 470. Different compressors/blowers and various numbers of stages may be used to suit a particular application. In one embodiment, with approximately 650 kW of blower input power, the system is able to transfer approximately 6,600 kW of thermal energy. In an alternative embodiment, the heat from each stage is transferred to the column reboiler.

Leaving the DDS column reboiler heat exchanger 469, the compressed partially condensed DDS column vapor 466′ is exchanged with the concentrate column reboiler 472. The concentrate column 462 is run under a vacuum (approximately 0.2-0.7 atm absolute pressure) in order to reduce the boiling temperature of the reboiler loop water supplying steam to the column in order to exchange the remaining latent heat of the DDS column vapor with the concentrate column reboiler 472. Leaving the concentrate column reboiler heat exchanger 473, the mostly condensed DDS column vapor 466″ is fully condensed in a final condenser 474 utilizing cooling water, thereby forming the concentrated draw solution (CDS) 416.

In some embodiments, for example, where the vapor exiting the column contains essentially no liquid portion, there is nothing for the draw solutes (e.g., ammonia and carbon dioxide in gaseous form) to be compressed into. The solutes could transition from the gaseous phase directly to the solid phase (e.g., crystallization), which could potentially render the recovery system 422 inoperable. Where that may be the case, the system 422 can include a by-pass line 461 for directing a portion of the dilute draw solution 420 to the compression operation, thereby providing a liquid for absorbing the gaseous solutes. In some embodiments, the introduction of the dilute draw solution may expedite the absorption of the CO₂. As shown, the dilute draw solution can be combined with the vapor 466 before or after any particular compressor to suit a particular application (e.g., a single compressor or series of compressors, the nature of the draw solutes, etc.). Additionally, the dilute draw solution can also be used to provide the liquid injection at the identified points. The by-pass line 461 can include any number and combination of valves and sensors as necessary to suit a particular application.

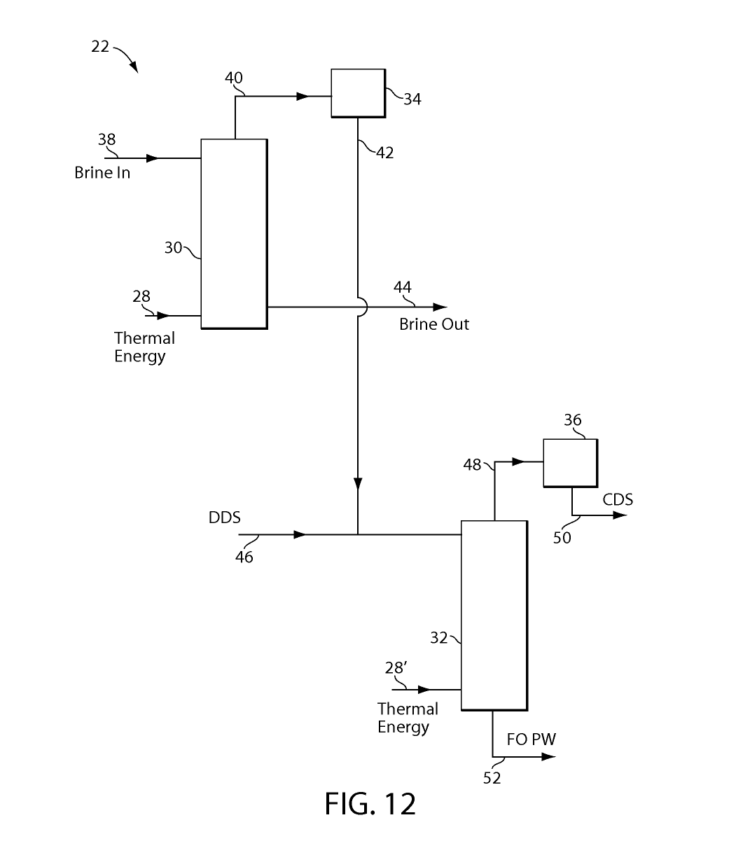

FIGS. 12-14 are simplified schematic representations of alternative systems for recovering draw solutes and include portions of the overall osmotically driven membrane system including, for example, brine strippers for further concentrating the residual brine from the membrane system. Essentially, one column is removing draw solutes from the dilute draw solution and one column is removing draw solutes from the concentrated brine that may have reverse fluxed through the membrane. The integration of the two columns generally reduces the energy requirements of the system.

As shown in FIG. 12, the system 22 includes a brine stripper column 30 and a dilute draw solution column 32. Brine 38 and dilute draw solution 46 are introduced into their respective columns, along with a source of thermal energy 28, 28′. Draw solutes and/or water are vaporized out of the brine stripper column 30. The vapor 40 is directed to a condenser 34, the output 42 of which is directed to the input of the draw solution column 32. The further concentrated brine 44 is outputted from the bottom of the column 30, where it can be sent for further processing or otherwise discarded. The draw solutes 48 vaporized out of the draw solution column 32 are directed to another condenser 36, the output of which is concentrated draw solution 50 (CDS). From the bottom of the column 32, the product solvent (FOPW) 52 is recovered for use or further processing.

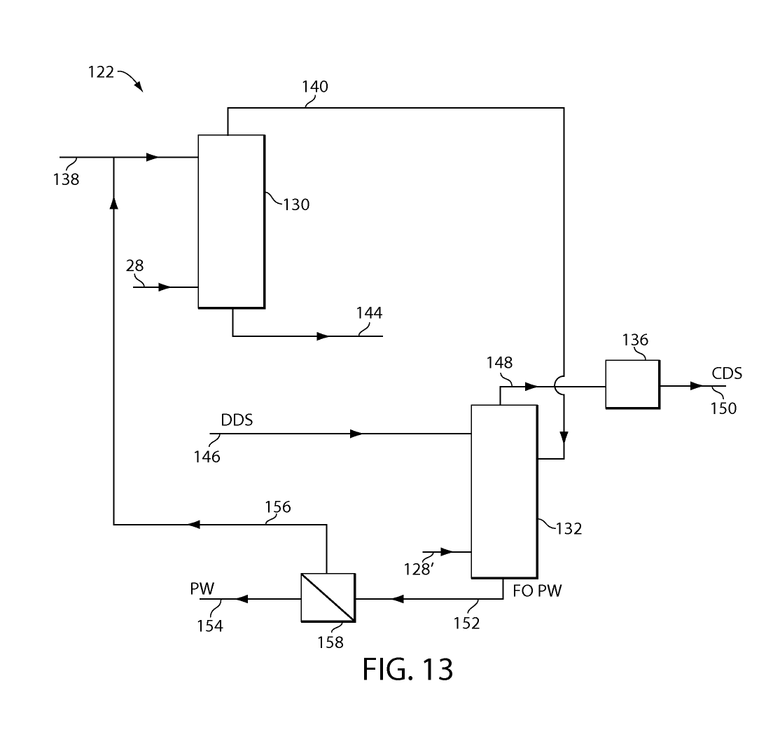

FIG. 13 depicts a similar system 122 that includes a brine stripper column 130, a dilute draw solution column, a condenser 136, and a reverse osmosis unit 158. As shown, the vapor 140 from the brine stripper column 130 is directed to the draw solution column 132 as a source of thermal energy. The vapor 148 from column 132 is directed to the condenser 136 to produce the concentrated draw solution 150. The product solvent 152 from the bottom of the column 132 is directed to the reverse osmosis unit 158 to produce the purified solvent 154 and RO reject 156. The RO reject 156 is directed to the input 138 of the brine stripper column 130.

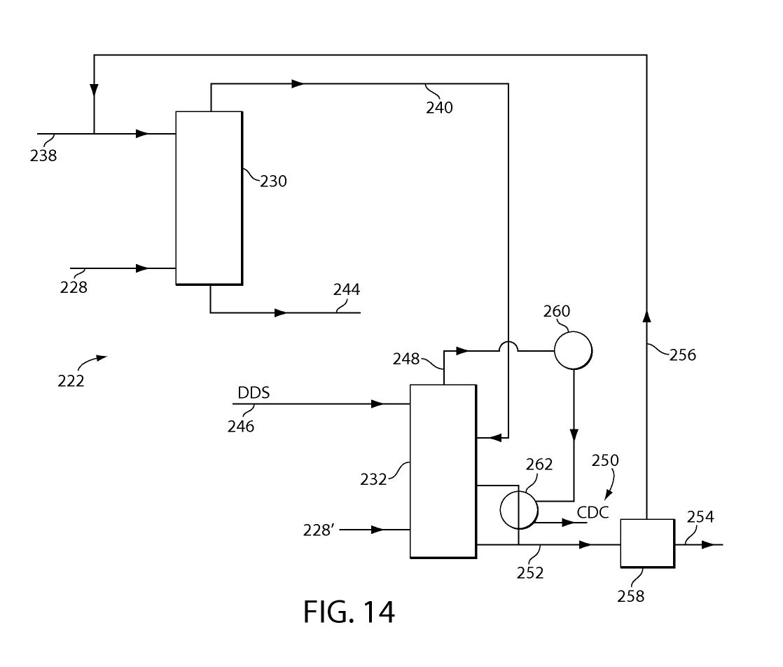

FIG. 14 depicts yet another similar system 222, where the system 222 also includes a brine stripper column 230, a dilute draw solution column 232, a blower or compressor 260, and a reverse osmosis unit 258. The vapor 248 from column 232 is directed to the blower 260, where it is compressed and its temperature raised, and then fed to the draw solution column reboiler 262. The vapor condensed within the reboiler forms the concentrated draw solution 250. Similar to the system 122 of FIG. 13, the product solvent 252 from the bottom of the draw solution column 232 is directed to the reverse osmosis unit 258 to produce the purified solvent 254 and RO reject 256, which is again directed to the input 238 of the brine stripper column 230. In some embodiments, thermal energy may be supplied for boiler start-up (228, 228′); however, depending on the operation of the system, this initial thermal energy 228, 228′ may be discontinued if enough thermal energy is supplied via the compressor circuit.

Additional improvements to the recovery process can include using piperazine or a piperazine moiety or a specialized enzyme to enhance the efficiency of the condensation and absorption process, where these chemicals are fixed to the surface of a packing material. Further, the process can be intimately integrated into the larger picture of carbon sequestration technology to form a type of super green machine that aids in carbon sequestration from the atmosphere and desalinates seawater with low grade heat. Essentially the premise would be purposefully harvesting CO2 from a fossil fuel burning energy plant that employs aqueous ammonia to sequester CO2. The system would take a bleed stream of this fluid and use it as the draw solution, intimately tying the osmotically driven membrane process to cogeneration or low grade heat harvesting from the plant.

In accordance with one or more embodiments, the devices, systems and methods described herein may generally include a controller for adjusting or regulating at least one operating parameter of a device or a component of the systems, such as, but not limited to, actuating valves and pumps, as well as adjusting a property or characteristic of one or more fluid flow streams through an osmotically driven membrane module, or other module in a particular system. A controller may be in electronic communication with at least one sensor configured to detect at least one operational parameter of the system, such as a concentration, flow rate, pH level, or temperature. The controller may be generally configured to generate a control signal to adjust one or more operational parameters in response to a signal generated by a sensor. For example, the controller can be configured to receive a representation of a condition, property, or state of any stream, component, or subsystem of the osmotically driven membrane systems and associated recovery systems. The controller typically includes an algorithm that facilitates generation of at least one output signal that is typically based on one or more of any of the representation and a target or desired value such as a set point. In accordance with one or more particular aspects, the controller can be configured to receive a representation of any measured property of any stream, and generate a control, drive or output signal to any of the system components, to reduce any deviation of the measured property from a target value.

In accordance with one or more embodiments, process control systems and methods may monitor various concentration levels, such as may be based on detected parameters including pH and conductivity. Process stream flow rates and tank levels may also be controlled. Temperature and pressure may be monitored, along with other operational parameters and maintenance issues. Various process efficiencies may be monitored, such as by measuring product water flow rate and quality, heat flow and electrical energy consumption. Cleaning protocols for biological fouling mitigation may be controlled such as by measuring flux decline as determined by flow rates of feed and draw solutions at specific points in a membrane system. A sensor on a brine stream may indicate when treatment is needed, such as with distillation, ion exchange, breakpoint chlorination or like protocols. This may be done with pH, ion selective probes, Fourier Transform Infrared Spectrometry (FTIR), or other means of sensing draw solute concentrations. A draw solution condition may be monitored and tracked for makeup addition and/or replacement of solutes. Likewise, product water quality may be monitored by conventional means or with a probe such as an ammonium or ammonia probe. FTIR may be implemented to detect species present providing information which may be useful to, for example, ensure proper plant operation, and for identifying behavior such as membrane ion exchange effects.

Having now described some illustrative embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in any claims. Further, acts, elements, and features discussed only in connection with one embodiment are not intended to be excluded from a similar role in other embodiments.

Furthermore, those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is, therefore, to be understood that the embodiments described herein are presented by way of example only and that the invention may be practiced otherwise than as specifically described.

What is claimed is:

1. A draw solution for an osmotically driven membrane system, the draw solution comprising:
an aqueous solvent having a pH in the range of 2-11; and
a draw solute comprising a cation source including at least one volatile gas-based cation and an anion source including at least one volatile gas-based anion, wherein the anion source further comprises a viscosity modifier.

2. The draw solution of claim 1, wherein the cation source comprises an alkyl amine having a boiling point less than water and the viscosity modifier comprises hydrogen sulfide.

3. The draw solution of claim 1, wherein the cation source comprises a blend of cations.

4. The draw solution of claim 3, wherein the blend of cations comprises one or more of an alkyl amine, ammonia, and sodium hydroxide.

5. The draw solution of claim 1, wherein the anion source comprises a blend of anions.

6. The draw solution of claim 5, wherein the blend of anions comprises one or more of hydrogen sulfide, carbon dioxide, hydrogen chloride, sulfur dioxide, and sulfur trioxide.

7. The draw solution of claim 1, wherein the viscosity modifier comprises at least one of ethanol, polyoxyalkylene, sodium xylene sulfonate, polyacrylics, sodium lauryl sulfonate, ethers, sulfides, and combinations thereof.

8. A draw solution recovery method for a draw solution comprising one or more thiol based draw solutes, the method comprising the steps of:
introducing a dilute draw solution comprising a solvent and at least one thiol based draw solute to an oxidizing environment;
stripping hydrogen ions from the draw solute;
passing the hydrogen ions across a barrier;
bonding the remaining solute via disulfide polymerization;
directing the solvent and polymerized solutes to a filtration module;
separating at least a portion of the solvent from the polymerized solute to produce a product solvent;
directing the polymerized solute and any remaining solvent to a reducing environment;
depolymerizing the polymerized solute; and
reintroducing the hydrogen ions to the depolymerized draw solute to reform the at least one thiol based draw solute and create a concentrated draw solution.

9. The method of claim 8, further comprising the step of directing the concentrated draw solution to an osmotically driven membrane system.

10. The method of claim 8, wherein the dilute draw solution is introduced from an osmotically driven membrane system.

11. The method of claim 8, wherein the filtration module comprises a reverse osmosis module.

12. The method of claim 8, wherein the oxidizing environment and the reducing environment are part of a redox cell separated by a hydrogen permeable barrier.

13. An osmotically driven membrane system comprising:
a forward osmosis membrane module comprising one or more membranes;
a source of a feed solution in fluid communication with one side of the one or more membranes;
a source of concentrated draw solution in fluid communication with an opposite side of the one or more membranes, wherein the draw solution comprises an aqueous solvent having a pH in the range of 2-11 and a draw solute comprising a cation source including at least one volatile gas-based cation and an anion source including at least one volatile gas-based anion, wherein the anion source further comprises a viscosity modifier; and
a draw solution recovery system in fluid communication with the forward osmosis membrane module.

14. The system of claim 13, wherein the draw solution recovery system comprises:
at least one redox cell in fluid communication with the opposite side of the one or more membranes and configured for receiving a dilute draw solution from the forward osmosis membrane module, the at least one redox cell comprising an oxidizing environment and a reducing environment separated by a hydrogen permeable barrier; and
a filtration module in fluid communication with the at least one redox cell.

15. The system of claim 14 further comprising an energy source in communication with the at least one redox cell.
